(19) United States
(12) Patent Application Publication
(10) Pub. No.: US 2026/0136405 A1
(43) Pub. Date: May 14, 2026

(54) RANDOM ACCESS PROCEDURES FOR DIFFERENT RANDOM ACCESS OCCASION TYPES

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Ahmed Attia ABOTABL, San Diego, CA (US); Yan ZHOU, San Diego, CA (US)

(21) Appl. No.: 19/354,369

(22) Filed: Oct. 9, 2025

Related U.S. Application Data
(60) Provisional application No. 63/718,353, filed on Nov. 8, 2024.

(51) Int. Cl. H04W 74/0838; H04L 5/00

(52) U.S. Cl. CPC H04W 74/0838; H04L 5/0044

(57) ABSTRACT

Methods, systems, and devices for wireless communications are described. A user equipment (UE) may receive a control signal that configures a contention-free random access procedure at the UE. The control signal may indicate a random access channel preamble index and a random access channel mask index. The UE may select a first random access occasion for the contention-free random access procedure between a first random access occasion type in a sub-band full duplex slot and a second random access occasion type in an uplink slot based on an absence of a random access occasion type configuration for the contention-free random access procedure. The UE may transmit a first random access preamble via the first random access occasion according to the random access channel mask index. Additional techniques for random access preamble retransmission and contention-based random access procedures are described.

### CROSS REFERENCES

The present application for patent claims benefit of U.S. Provisional Patent Application No. 63/718,353 by ABDELGHAFFAR et al., entitled “RANDOM ACCESS PROCEDURES FOR DIFFERENT RANDOM ACCESS OCCASION TYPES,” filed Nov. 8, 2024, assigned to the assignee hereof, and expressly incorporated herein.

### FIELD OF TECHNOLOGY

The following relates to wireless communications, including random access procedures for different random access occasion types.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A wireless communications systems may support communications via sub-band full duplex (SBFD) slots, where a SBFD slot may include both uplink and downlink resources. A user equipment (UE) which is capable of SBFD communications may be able to transmit uplink signaling via the uplink resources of an SBFD slot or receive downlink signaling via downlink resources of the SBFD slot. A UE that is not capable of SBFD communications may be able to use the downlink resources of the SBFD slot but not the uplink resources of the SBFD slot. In some examples, an SBFD slot may be configured to include a first type of random access occasions which are usable by SBFD-capable UEs. A UE that is not capable of SBFD communications may be configured with a second type of random access occasion that falls on uplink or flexible slots. A UE that supports SBFD communications may be able to use both types of random access occasion to transmit a random access preamble for a random access procedure or use to transmit early indication information. When a UE is configured to perform a random access procedure, such as a contention-free random access (CFRA) procedure, the UE may be configured with a type of random access occasion for the random access procedure

A wireless communications system described herein provides techniques for a UE that is capable of SBFD communications to perform a random access procedure when both types of random access occasions are configured. In some examples, the UE may select a random access occasion type when the UE is configured for a CFRA procedure, but the UE is not configured with a random access occasion type for the CFRA procedure. In some examples, the UE may use, or prioritize, random access occasions that are in an SBFD slot (e.g., the first type of random access occasion). In some examples, the UE may use random access occasions that are in uplink slots (e.g., the second type of random access occasion). In some examples, the UE may use a random access occasion based on a configuration for a CBRA procedure. In some examples, an initial random access procedure may fail, and the UE may select a random access occasion type or random access procedure type (e.g., between contention-free and CBRA procedures) for retransmission of a random access preamble when an initial CFRA procedure fails. For example, the UE may continue performing a CFRA procedure using a same type of random access occasion, or the UE may switch random access occasion type or random access procedure type, for example, based on performing a threshold quantity of retransmissions. In some examples, the UE may be configured to perform a CBRA procedure, and the UE may select between the first type of random access occasion and the second type of random access occasion.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random access procedures for different random access occasion types in accordance with one or more aspects of the present disclosure.

FIG. 2 shows an example of a wireless communications system that supports random access procedures for different random access occasion types in accordance with one or more aspects of the present disclosure.

FIG. 3 shows an example of a random access retransmission scheme that supports random access procedures for different random access occasion types in accordance with one or more aspects of the present disclosure.

FIG. 4 shows an example of a process flow that supports random access procedures for different random access occasion types in accordance with one or more aspects of the present disclosure.

FIG. 5 shows an example of a process flow that supports random access procedures for different random access occasion types in accordance with one or more aspects of the present disclosure.

FIG. 6 shows an example of a process flow that supports random access procedures for different random access occasion types in accordance with one or more aspects of the present disclosure.

FIGS. 7 and 8 show block diagrams of devices that support random access procedures for different random access occasion types in accordance with one or more aspects of the present disclosure.

FIG. 9 shows a block diagram of a communications manager that supports random access procedures for different random access occasion types in accordance with one or more aspects of the present disclosure.

FIG. 10 shows a diagram of a system including a device that supports random access procedures for different random access occasion types in accordance with one or more aspects of the present disclosure.

FIGS. 11 through 13 show flowcharts illustrating methods that support random access procedures for different random access occasion types in accordance with one or more aspects of the present disclosure.

### DETAILED DESCRIPTION

A wireless communications systems may support sub-band full duplex (SBFD) communications, where a slot may include both uplink and downlink resources. A user equipment (UE) which is capable of SBFD communications may be able to transmit uplink signaling via the uplink resources of an SBFD slot or receive downlink signaling via downlink resources of the SBFD slot. A UE that is not capable of SBFD communications may be able to use the downlink resources of the SBFD slot but not the uplink resources of the SBFD slot. For a random access procedure, a UE that is not capable of SBFD communications may be configured with a type of random access occasion that falls on “legacy” uplink or flexible slots. In some examples, an SBFD slot may be configured to include one or more “additional” random access occasions, or a different type of random access occasion. A UE that supports SBFD communications may be able to use the different type of random access occasion to transmit a random access preamble for a random access procedure or use to transmit early indication information. If both types of random access occasions (e.g., legacy random access occasions and SBFD random access occasions) are configured, the network entity may indicate a random access occasion type the UE is to use for the contention-free random access (CFRA) procedure.

Current wireless communications systems do not provide techniques for various aspects of a random access procedure when utilizing both types of random access occasion. For example, there may be scenarios where the random access occasion type is not configured, and both random access occasion types are available for the UE. Current systems do not provide techniques for a UE to select a type of random access occasion when the random access occasion type is not configured. In some examples, an initial random access preamble transmission may fail, and the UE may attempt to retransmit the random access preamble. Current systems do not provide techniques for handling random access preamble retransmission with multiple random access occasion types. Additionally, the UE may be triggered for a contention-based random access (CBRA) procedure while configured for both random access occasion types. Current systems do not provide techniques for selecting between the random access occasion types for a CBRA procedure.

A wireless communications system described herein provides techniques for a UE that is capable of SBFD communications to perform a random access procedure when both types of random access occasions are configured. In some examples, the UE may select a random access occasion type when the UE is configured for a CFRA procedure, but the UE is not configured with a random access occasion type for the CFRA procedure. In some examples, the UE may use, or prioritize, random access occasions that are in an SBFD slot (e.g., the first type of random access occasion). In some examples, the UE may use random access occasions that are in uplink slots (e.g., the second type of random access occasion). In some examples, the UE may use a random access occasion based on a configuration for a CBRA procedure. In some examples, an initial random access procedure may fail, and the UE may select a random access occasion type or random access procedure type (e.g., between contention-free and CBRA procedures) for retransmission of a random access preamble when an initial CFRA procedure fails. For example, the UE may continue performing a CFRA procedure using a same type of random access occasion, or the UE may switch random access occasion type or random access procedure type, for example, based on performing a threshold quantity of retransmissions. In some examples, the UE may be configured to perform a CBRA procedure, and the UE may select between the first type of random access occasion and the second type of random access occasion.

Aspects of the disclosure are initially described in the context of wireless communications systems. Aspects of the disclosure are further illustrated by and described with reference to apparatus diagrams, system diagrams, and flowcharts that relate to random access procedures for different random access occasion types.

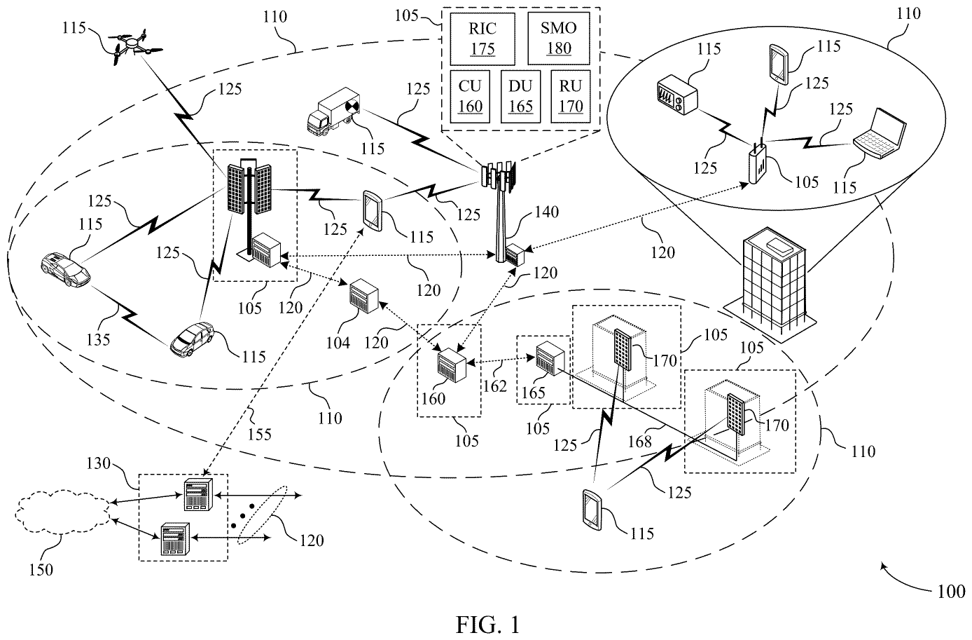

FIG. 1 shows an example of a wireless communications system 100 that supports random access procedures for different random access occasion types in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (CNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support random access procedures for different random access occasion types as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications systems 100 may support SBFD communications, where a slot may include both uplink and downlink resources. A UE 115 which is capable of SBFD communications may be able to transmit uplink signaling via the uplink resources of an SBFD slot or receive downlink signaling via downlink resources of the SBFD slot. A UE 115 that is not capable of SBFD communications may be able to use the downlink resources of the SBFD slot but not the uplink resources of the SBFD slot.

For a random access procedure, a UE 115 that is not capable of SBFD communications may be configured with a type of random access occasion that falls on “legacy” uplink or flexible slots. In some examples, an SBFD slot may be configured to include one or more “additional” random access occasions, or a different type of random access occasion. A UE 115 that supports SBFD communications may be able to use the different type of random access occasion to transmit a random access preamble for a random access procedure or use the different type of random access occasion to transmit early indication information. If both types of random access occasions (e.g., legacy random access occasions and SBFD random access occasions) are configured, the network entity may indicate a random access occasion type the UE 115 is to use for the CFRA procedure. In some examples, a random access preamble may be transmitted via Message 1 of a four-step random access procedure or via Message A of a two-step random access procedure. Message A of a two-step random access procedure may include information from Message 1 and Message 3 of a four-step random access procedure.

In some examples, the first type of random access occasions (e.g., associated with SBFD slots) and the second type of random access occasions (e.g., associated with uplink or flexible slots) may have a common or shared random access channel configuration. For example, the first type of random access occasion and the second type of random access occasion may have a single random access channel configuration index. In some other examples, the first type of random access occasion and the second type of random access occasion may be configured separately. For example, the first type of random access occasion may be configured by a first random access channel configuration with a first random access channel configuration index, and the second type of random access occasion may be configured by a second random access channel configuration with a second random access channel configuration index.

In some cases, a network entity 105 may configure a UE 115 to perform a random access procedure by transmitting downlink control channel signaling to the UE 115. For example, the network entity 105 may transmit physical downlink control channel (PDCCH) signaling including downlink control information that triggers the random access procedure at the UE 115. The mechanism to configure a UE 115 to perform a random access procedure via PDCCH signaling may be referred to as a PDCCH order.

A PDCCH order may be transmitted using downlink control information format 1_0 with a cell radio network temporary identifier (C-RNTI). A UE 115 may determine the downlink control information corresponds to a PDCCH order if a frequency domain resource allocation (FDRA) field of the downlink control information is set to all Is, in which case the downlink control information indicates parameters associated with the random access procedure. For example, the downlink control information may indicate a random access preamble index, an uplink or supplementary uplink indication, a synchronization signal block (SSB) index, and a random access channel mask index. If the random access preamble index is set to 0, the PDCCH order may trigger a CBRA procedure, and the UE 115 may ignore the other fields. If the random access preamble index is set to a value other than 0, the PDCCH order may trigger a CFRA procedure.

The UE 115 may transmit a random access preamble in an indicated random access occasion for a CFRA procedure or in a random access occasion associated with a measured SSB for a CBRA procedure. After random access preamble transmission, the UE 115 may monitor for PDCCH signaling with a CRC scrambled with a random access RNTI (RA-RNTI) which schedules a random access response physical downlink shared channel (PDSCH). When a CFRA procedure is on a primary cell or a primary secondary cell, the UE 115 may assume the PDCCH with the RA-RNTI is quasi co-located with the PDCCH order. In some examples, the UE 115 may assume the PDSCH carrying the random access response is quasi co-located with the PDCCH order.

In some examples, a random access channel mask index may be configured in a random access channel configuration. If the random access preamble index value is not set to 0, the random access channel mask index may indicate a random access channel occasion associated with the SSB indicated by an SSB index for the random access channel preamble transmission. The random access channel mask index may assign a dedicated preamble index to the UE 115 for the random access procedure. For example, the random access channel mask index may define random access channel occasions associated with an SSB in which a MAC entity at the UE 115 may transmit a random access preamble. If an SSB is selected, the UE 115 may determine a next available random access channel occasion from the random access channel occasions corresponding to the selected SSB based on the random access channel mask index (e.g., if configured), a shared random access occasion mask index (e.g., if configured), or indicated by a PDCCH order. An indicated SSB index may be associated with up to eight random access occasion indices. The random access channel mask index may indicate which random access occasions may be used by the UE 115 to transmit the random access preamble.

A UE 115 may be triggered to perform a random access procedure for one or more events. For example, the UE 115 may be triggered to perform the random access procedure for a handover, for downlink data arrival if the UE 115 is out of sync with a network entity 105, for on-demand system information, for beam failure recovery, synchronous reconfiguration, and to establish time alignment during a secondary cell addition.

A UE 115 may determine a transmission power for a random access channel, P_{PRACH,b,f,c}(i) on an active uplink bandwidth part b of carrier f on cell c based on a downlink reference signal for cell c in transmission occasion i according to Equation (1).

$${P}_{PRACH , b , f , c} ( i ) = min \{ {P}_{CMAX , f , c} ( i ) , {P}_{PRACH , target , f , c} + P {L}_{b , f , c} \} \qquad ( 1 )$$

In Equation (1), P_{CMAX,f,c}(i) corresponds to a UE-configured maximum transmission output power for carrier f of cell c within transmission occasion i. In Equation (1), P_{RACH,target,f,c}, corresponds to a random access channel target reception power parameter indicated by higher layer signaling for the active uplink bandwidth part b of carrier f of cell c. In Equation (1), PL_{b,f,c} corresponds to a pathloss for the active uplink bandwidth part b of carrier f based on the downlink reference signal associated with the random access channel transmission on the active downlink bandwidth part of cell c and determined by the UE 115 in decibels. If the UE 115 does not receive a random access response that includes a preamble identifier corresponding to a preamble sequence transmitted by the UE 115, or if a random access response window does not exist, the UE 115 may determine a transmission power for a subsequent random access channel transmission according a power ramping configuration, delta power control parameters, and the preamble received target power value of the random access channel configuration.

In some cases, a network entity 105 may dynamically indicate a random access occasion type for a UE 115 to use for a random access procedure. For example, the network entity 105 may indicate the random access occasion type for random access procedures configured via PDCCH order and some UE dedicated random access procedures, such as those for a system information request, a handover, and beam failure recovery. For example, the network entity 105 may include a bit in the downlink control information of a PDCCH order or a bit in a semi-static configuration for a dedicated random access channel configuration that indicates the random access occasion type for the random access procedure.

However, there may be scenarios where the random access occasion type is not configured, and both random access occasion types are available for the UE 115. For example, the UE 115 may be triggered to perform a CFRA procedure before receiving a semi-static dedicated random access channel configuration, and the signal triggering the CFRA procedure may not indicate a random access occasion type. In some cases, a random access occasion type may not be configured in the semi-static dedicated random access channel configuration or indicated by the PDCCH order. In some systems, the UE 115 may not have techniques to select a random access occasion type when the random access occasion type is not configured or indicated to the UE 115.

In some examples, an initial random access preamble transmission may fail, and the UE 115 may attempt to retransmit the random access preamble. Current systems do not provide techniques for handling random access preamble retransmission with multiple random access occasion types. Additionally, the UE 115 may be triggered for a CBRA procedure while configured for both random access occasion types. Current systems do not provide techniques for selecting between the random access occasion types for a CBRA procedure.

The wireless communications system 100 may implement techniques for a UE 115 to select a random access occasion type when the UE 115 is configured for a CFRA procedure, but the UE 115 is not configured with a random access occasion type for the CFRA procedure. In some examples, the UE 115 may use, or prioritize, random access occasions that are in a sub-band full duplex slot (e.g., “additional” random access occasions). In some examples, the UE 115 may use random access occasions that are in uplink slots (e.g., “legacy” random access occasions). In some examples, the UE 115 may use a random access occasion based on a configuration for a CBRA procedure. For example, the UE 115 may select a random access occasion type based on whether a reference signal measurement satisfies a threshold used to determine a random access occasion type for a CBRA procedure. In some examples, the UE 115 may select a random access occasion type for the CFRA procedure based on a random access occasion type configured for a CBRA procedure.

The wireless communications system 100 may also support techniques for handling retransmission when an initial random access preamble transmission for a CFRA procedure fails. In some examples, the UE 115 may retransmit the random access preamble using a same random access occasion type for the rest of the random access procedure. In some examples, the UE 115 may switch random access occasion types for the CFRA procedure after a threshold quantity of retransmission attempts. In some examples, the UE 115 may switch to performing a CBRA procedure using a same random access occasion type, in some examples after a threshold quantity of retransmission attempts. In some examples, the UE 115 may switch to performing a CBRA procedure and switch the random access occasion type after a threshold quantity of attempts or retransmission attempts.

The wireless communications system 100 may also support techniques for selecting a random access occasion type for a CBRA procedure when both types of random access occasions are available. In some examples, the UE 115 may select the random access occasion type for the CBRA procedure based on a configured random access occasion type. In some examples, the UE 115 may ignore the configured random access occasion type, and the UE 115 may select a random access occasion type based on prioritizations or conditions configured for the CBRA procedure. For example, a signal that triggers the random access procedure may indicate to use a random access occasion in an uplink slot, but the UE 115 may select a random access occasion in an SBFD slot if an SSB measurement for the CBRA procedure satisfies a threshold.

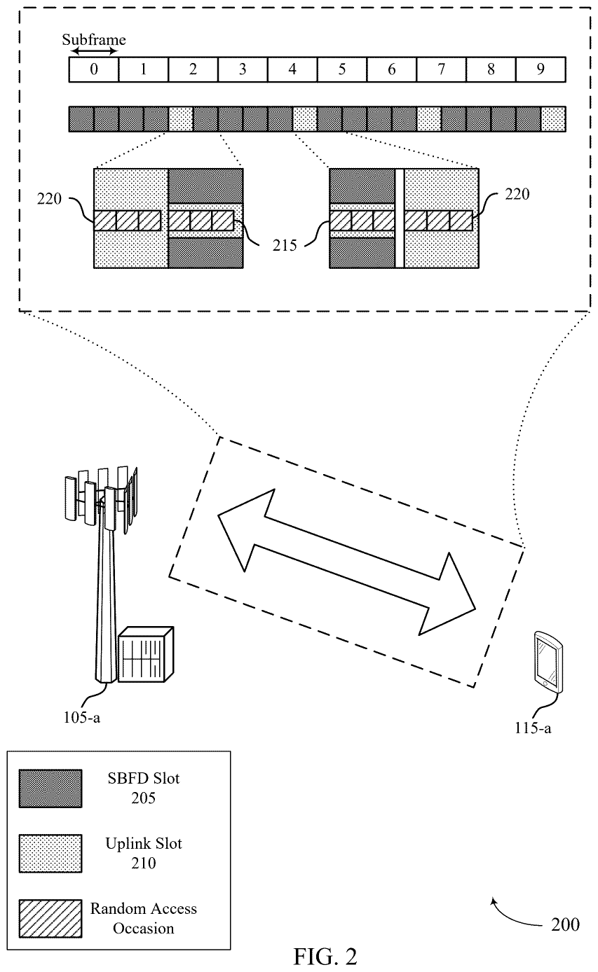

FIG. 2 shows an example of a wireless communications system 200 that supports random access procedures for different random access occasion types in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 described herein.

The UE 115-a may be a UE 115 which is capable of SBFD communications. For example, an SBFD slot 205 may include uplink resources which the UE 115-a may use to transmit uplink signaling to the network entity 105-a and receive downlink signaling from the network entity 105-a. For example, a SBFD slot 205 may be an example of a time-frequency resource allocation unit in communication systems that may support bidirectional communication within a single time slot by partitioning the available frequency spectrum into distinct sub-bands dedicated to uplink and downlink transmissions. The SBFD slot facilitates full duplex operation at a sub-band granularity level, wherein different frequency sub-bands or resource blocks within the same temporal slot are dynamically allocated for concurrent transmission and reception, which may support improved spectral efficiency and reduced communication latency relative to half-duplex slots (e.g., slots with uplink or downlink resources). A UE 115 which does not support SBFD communications or is not capable of SBFD communications may be able to transmit uplink signaling via an uplink slot 210 but not the uplink resources of the SBFD slot 205.

The network entity 105-a may configure a first type of random access occasion 215 in SBFD slots 205 and a second type of random access occasion 220 in uplink slots 210. The second type of random access occasion 220 may be configured in uplink slots 210 and may be used by the UE 115-a, or an SBFD-capable UE 115, and other UEs 115 which are not capable of SBFD communications. The first type of random access occasion 215, also referred to as additional random access occasions, may be configured in uplink resources of SBFD slots 205. A UE 115 which is capable of SBFD communication, such as the UE 115-a, may be configured to transmit a random access preamble via the first type of random access occasion 215 for a random access procedure. A UE 115 which is not capable of SBFD communications may not be able to use the first type of random access occasion 215.

In some examples, the network entity 105-a may transmit control signaling to indicate a random access channel configuration to the UE 115-a. For example, the network entity 105-a may indicate a dedicated random access channel configuration to the UE 115-a for a CFRA procedure. In some examples, the second type of random access occasion 220 and the first type of random access occasion 215 may have a common random access channel configuration or separate random access channel configurations. In some examples, the random access channel configuration may indicate a random access occasion type for a CFRA procedure. In some other examples, the random access channel configuration may not indicate a random access occasion type for a CFRA procedure.

In some examples, the network entity 105-a may configure the UE 115-a to perform a CFRA procedure. The UE 115-a may interpret a random access channel mask index based on a random access occasion type and transmit a random access preamble in a random access occasion by applying a mask corresponding to the random access channel mask index as described herein. For example, the network entity 105-a may transmit downlink control information to the UE 115-a to perform the CFRA procedure via PDCCH order. Additionally, or alternatively, the UE 115-a may be configured to perform the CFRA procedure based on another condition or trigger.

In some examples, a random access occasion type for the CFRA procedure may not be configured at the UE 115-a. For example, a random access channel configuration for the CFRA procedure may not configure or specify a random access occasion type. Additionally, or alternatively, downlink control information for a PDCCH order may not configure or specify a random access occasion type for the CFRA procedure.

In some examples, the UE 115-a may use, or prioritize, the first type of random access occasion 215 for the CFRA procedure. The UE 115-a may transmit the random access preamble via a random access occasion of the first type of random access occasion 215 based on the random access preamble index and a random access channel mask index applied to the first type of random access occasion 215. For example, the UE 115-a may apply the random access channel mask to the first type of random access occasion 215 in an SBFD slot 205.

In some examples, the UE 115-a may use, or prioritize, the second type of random access occasion 220 for the CFRA procedure. For example, the UE 115-a may treat the random access preamble transmission as a first random access preamble transmission using a second type of random access occasion 220. The UE 115-a may apply the random access channel mask index to random access occasions of the second type of random access occasion 220 (e.g., in an uplink slot 210) and transmit the random access preamble via a selected random access occasion of the second type of random access occasion 220.

In some examples, the UE 115-a may select a random access occasion for the CFRA procedure based on a configuration for a CBRA procedure. For example, the UE 115-a may select a random access occasion type based on whether a reference signal measurement, such as a reference signal received power (RSRP) measurement, satisfies a threshold. The UE 115-a may use a measurement comparison to the threshold to determine a random access occasion type for a CBRA procedure. For example, if the reference signal measurement satisfies the threshold, the UE 115-a may select first type of random access occasion 215. If the reference signal measurement fails to satisfy the threshold, the UE 115-a may use the second type of random access occasion 220. In some examples, the configuration for the CBRA procedure may include a prioritization for one of the random access occasion types. For example, the network entity 105-a may semi-statically indicate a random access occasion type to prioritize for the CBRA procedure, or the network entity 105-a may indicate a prioritized random access occasion type via SIB signaling.

In some examples, the UE 115-a may select a random access occasion type for the CFRA procedure based on a random access occasion type configured for a CBRA procedure. For example, the network entity 105-a may indicate a random access occasion type the UE 115-a is to prioritize for a CBRA procedure. If the UE 115-a is configured for a CFRA procedure, but a random access occasion type is not configured or absent for the CFRA procedure, the UE 115-a may use the same type of random access occasion that is configured or prioritized for a CBRA procedure.

The wireless communications system 200 may support techniques for handling retransmission when an initial random access preamble transmission for a CFRA procedure fails. For example, the UE 115-a may transmit a random access preamble for a CFRA procedure, but communication of the random access preamble may fail. For example, the network entity 105-a may be unable to decode the random access preamble based on poor channel conditions. The initial random access preamble may be transmitted via the second type of random access occasion 220 or the first type of random access occasion 215. In some examples, a signal that configures or triggers the random access procedure may indicate the random access occasion type.

In some examples, the UE 115-a may retransmit the random access preamble using a same random access occasion type for the rest of the random access procedure. For example, if the UE 115-a transmits the initial random access preamble for a CFRA procedure using the first type of random access occasion 215, the UE 115-a may perform retransmissions using the first type of random access occasion 215 until the UE 115-a completes the CFRA.

In some examples, the UE 115-a may switch random access occasion types for the CFRA procedure after a threshold quantity of retransmission attempts. In some examples, the network entity 105-a may configure the UE 115-a with the threshold quantity of retransmission attempts. For example, the network entity 105-a may indicate the threshold quantity of attempts to the UE 115-a. Additionally, or alternatively, the threshold quantity of attempts may be statically configured or specified for the wireless communications system 200.

For example, if the UE 115-a initially transmits the random access preamble using the first type of random access occasion 215, the UE 115-a may attempt retransmission of the random access preamble using the first type of random access occasion 215 until the UE 115-a perform a threshold quantity of retransmission attempts. After the threshold quantity of retransmission attempts is satisfied, the UE 115-a may attempt retransmission of the random access preamble using the second type of random access occasion 220. Similarly, the UE 115-a may switch from using the second type of random access occasion 220 to the first type of random access occasion 215 after a threshold quantity of retransmission attempts if the initial transmission uses the second type of random access occasion 220. In some cases, the UE 115-a may use a same preamble index and random access channel mask index on both random access occasion types. In some other examples, the UE 115-a may use different preamble indexes and random access channel mask indexes for the different random access occasion types. The network entity 105-a may configure the UE 115-a with a preamble index and a random access channel mask index for each random access occasion type.

In some examples, the UE 115-a may switch to performing a CBRA procedure using a same random access occasion type, in some examples after a threshold quantity of retransmission attempts. For example, if the UE 115-a initially transmits the random access preamble using the first type of random access occasion 215 for a CFRA, the UE 115-a may switch to performing a CBRA using the first type of random access occasion 215, in some examples after performing a threshold quantity of retransmission attempts. Switching from performing a CFRA procedure to a CBRA procedure may be an example of a fallback procedure. The UE may use a CBRA resource with a same random access occasion type as a CFRA resource when switching from CFRA operation to CBRA operation, for example based on the same type of random access occasion being configured for both CFRA procedures and CBRA procedures. In some examples, the UE 115-a may switch to performing a CBRA and switch random access occasion types after performing a threshold quantity of retransmission attempts.

In some examples, the first type of random access occasion 215 may be configured with different power control parameters than the second type of random access occasion 220. For example, the first type of random access occasion 215 may be configured with a different preamble received target power and a different power ramping step than the second type of random access occasion 220. When switching the random access occasion type or the random access procedure type, or both, the UE 115-a may maintain or change power control parameters.

In some examples, if the UE 115-a switches from performing a CFRA procedure to a CBRA procedure, the UE 115-a may select a different SSB index, and a pathloss value may change. The UE 115-a may use a pathloss reference signal of the new selected SSB index. In some examples, the UE 115-a may reset or suspend a preamble power ramping counter, such that a random access channel received target power is equal to preamble received target power set in the configuration for the CBRA procedure. In some other examples, the UE 115-a may not reset the preamble power ramping counter, and the UE 115-a may use the new pathloss reference signal of the selected SSB.

In some examples, if the UE 115-a switches random access occasion types but maintains random access procedure type, the UE 115-a may continue the power ramping counter and use the power control parameters of the other random access occasion type. The UE 115-a may apply a power offset based on delta power control parameters. The PRACH power may be incremented by a power ramping step size every time a PRACH attempts fails. When the RO type is switched, a power offset, defined according to Equation (2), is added and the UE 115-a may switch to using the preambleReceivedTargetPower and PreamblePowerRampingStep of the other RO type according to Equation (3).

$${P}_{{offset}_{RO - Switch}} = ( {preambleReceivedTargetPower}_{first - {RO}_{type}} - {preambleReceivedTargetPower}_{second - {RO}_{type}} ) + N \times ( {preambleReceivedTargetPower}_{second - {RO}_{type}} - {preambleReceivedTargetPower}_{first - {RO}_{type}} ) \qquad ( 2 )$$

$${P}_{PRACH , target , f , c} = {preambleReceivedTargetPower}_{RO - Type} + ( PREAMBLE\_POWER \_RAMPING \_COUNTER - 1 ) \times PREAMBLE\_POWER {\_RAMPINGstep}_{RO - Type} + {P}_{{offset}_{RO - Switch}} \qquad ( 3 )$$

In some other examples, if the UE 115-a switches random access occasion types but maintains random access procedure type, the UE 115-a may reset the power ramping counter and use the power control parameters of the other random access occasion type.

In some examples, the UE 115-a may be configured or triggered to perform a CBRA procedure. For example, a random access preamble index may be set to 0 in a PDCCH order, or the UE 115-a may be semi-statically configured to perform a CBRA procedure. In some examples, the UE 115-a may be indicated a random access occasion type for the CBRA procedure. For example, the PDCCH order may include a bitfield indicating the random access occasion type, or the random access occasion type may be configured via a semi-static random access channel configuration.

In some examples, the UE 115-a may use the random access occasion type as configured. For example, the UE 115-a may transmit a random access preamble for the CBRA procedure based on the configured random access occasion type or an indicated random access occasion type in the PDCCH order.

In some examples, the UE 115-a may ignore or select a random access occasion type based on conditions or metrics other than the indicated random access occasion type. For example, the UE 115-a may select the random access occasion type based on specific or configured conditions or prioritizations of an initial access CBRA procedure. For example, if a reference signal received power measurement satisfies a threshold, the UE 115-a may select the first type of random access occasion 215. IF the reference signal received power measurement fails to satisfy the threshold, the UE 115-a may select the second type of random access occasion 220. In some other examples, the UE 115-a may select a random access occasion type based on a prioritization specified in a configuration for the CBRA procedure.

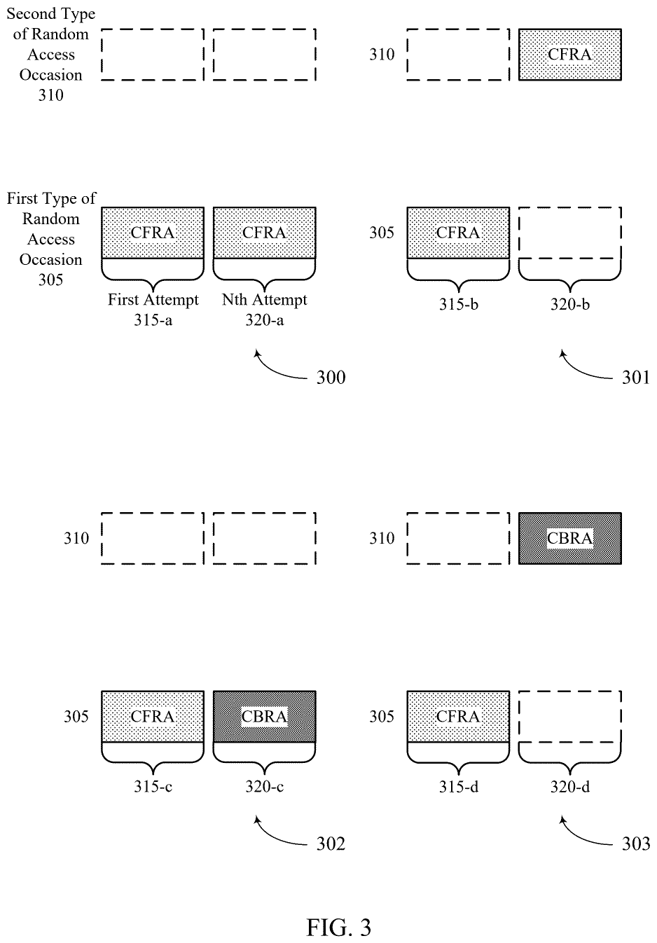

FIG. 3 shows an example of a random access retransmission scheme 300, 301, 302, and 303 that supports random access procedures for different random access occasion types in accordance with one or more aspects of the present disclosure. The random access retransmission schemes may implement aspects of a wireless communications system 100 or a wireless communications system 200 as described herein.

A wireless communications system may support techniques for handling retransmission when an initial random access preamble transmission for a CFRA procedure fails. For example, a UE 115 may transmit a random access preamble for a CFRA procedure, but communication of the random access preamble may fail. For example, a network entity 105 may be unable to decode the random access preamble based on poor channel conditions. The initial random access preamble may be transmitted via a first type of random access occasion 310 or a second type of random access occasion 305. In some examples, a signal that configures or triggers the random access procedure may indicate the random access occasion type.

For the random access retransmission scheme 300, the UE 115 may retransmit the random access preamble using a same random access occasion type for the rest of the random access procedure. For example, if the UE 115 transmits a random access preamble for a CFRA procedure during a first attempt 315-a using the first type of random access occasion 305. The UE 115 may perform retransmissions using the first type of random access occasion 305 until the UE 115 completes the CFRA. For example, the UE 115-a may retransmit the random access preamble using the first type of random access occasion 305 for an Nth attempt 320-a.

For the random access retransmission scheme 301, the UE 115 may switch random access occasion types for the CFRA procedure after a threshold quantity of attempts or retransmission attempts. For example, if the UE 115 transmits the random access preamble using the first type of random access occasion 305 for a first attempt 315-b, and the UE 115 may attempt retransmission of the random access preamble using the first type of random access occasion 305 until the UE 115 perform a threshold quantity of retransmission attempts. After satisfying the threshold quantity of retransmission attempts, the UE 115 may attempt retransmission of the random access preamble using the second type of random access occasion 310. For example, the UE 115 may transmit the random access preamble using the second type of random access occasion 310 for an Nth attempt 320-b. Similarly, the UE 115 may switch from using the second type of random access occasion 310 to the first type of random access occasion 305 after a threshold quantity of retransmission attempts if the initial transmission uses the second type of random access occasion 310.

In some examples, the UE 115 may use a same preamble index and random access channel mask index on both random access occasion types. In some other examples, the UE 115 may use different preamble indexes and random access channel mask indexes for the different random access occasion types. The network entity 105 may configure the UE 115 with a preamble index and a random access channel mask index for each random access occasion type.

In some examples, the UE 115 may switch to performing a CBRA procedure using a same random access occasion type after a threshold quantity of retransmission attempts. For the random access retransmission scheme 302, the UE 115 may switch random access procedure types after a threshold quantity of retransmission attempts. For example, if the UE 115 initially transmits the random access preamble for a first attempt 315-c using the first type of random access occasion 305 for a CFRA, the UE 115 may switch to performing a CBRA using the first type of random access occasion 305 for an Nth attempt 320-c, in some examples after performing a threshold quantity of retransmission attempts.

For the random access retransmission scheme 303, the UE 115 may switch to random access procedure types and random access occasion types after performing a threshold quantity of retransmission attempts. For example, the UE 115 may use the first type of random access occasion 305 for a first attempt 315-d according to a CFRA procedure, and the UE 115 may use the second type of random access occasion 310 for an Nth attempt 320-d according to a CBRA procedure.

In some examples, the first type of random access occasion 305 may be configured with different power control parameters than the second type of random access occasion 310. For example, the first type of random access occasion 305 may be configured with a different preamble received target power and a different power ramping step than the second type of random access occasion 310. When switching the random access occasion type or the random access procedure type, or both, the UE 115 may maintain or change power control parameters.

In some examples, if the UE 115 switches from performing a CFRA procedure to a CBRA procedure, the UE 115 may select a different SSB index, and a pathloss value may change. The UE 115 may use a pathloss reference signal of the new selected SSB index. In some examples, the UE 115 may reset or suspend a preamble power ramping counter, such that a random access channel received target power is equal to preamble received target power set in the configuration for the CBRA procedure. In some other examples, the UE 115 may not reset the preamble power ramping counter, and the UE 115 may use the new pathloss reference signal of the selected SSB.

In some examples, if the UE 115 switches random access occasion types but maintains random access procedure type, the UE 115 may continue the power ramping counter and use the power control parameters of the other random access occasion type. The UE 115 may apply a power offset based on delta power control parameters. In some other examples, if the UE 115 switches random access occasion types but maintains random access procedure type, the UE 115 may reset the power ramping counter and use the power control parameters of the other random access occasion type.

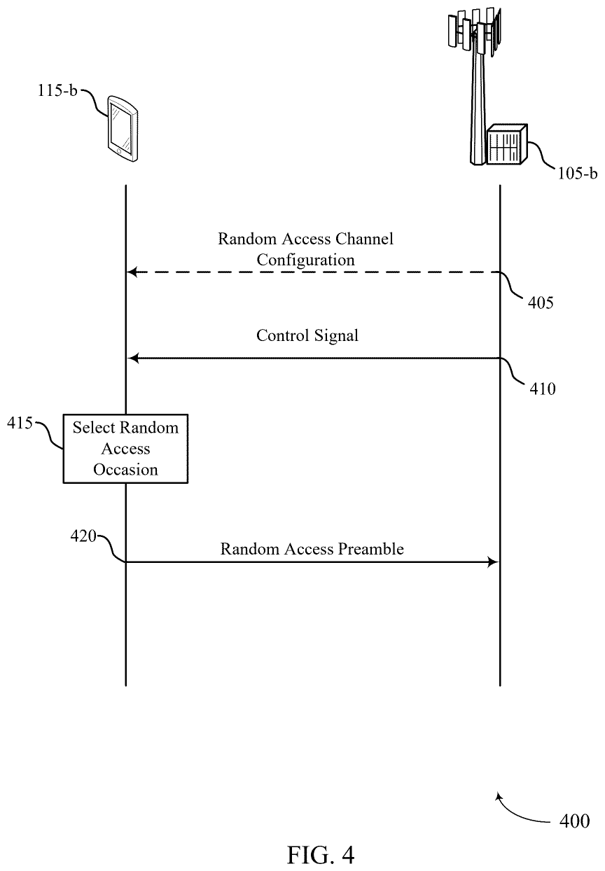

FIG. 4 shows an example of a process flow 400 that supports random access procedures for different random access occasion types in accordance with one or more aspects of the present disclosure. The process flow 400 may implement aspects of a wireless communications system 100 and a wireless communications system 200 described herein. For example, the process flow 400 may be implemented by a UE 115-b and a network entity 105-b, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 400, some aspects of some operations may also be performed by one or more other wireless devices.

The process flow 400 may correspond to an example of the UE 115-b selecting between a first random access occasion type and a second random access occasion type for a CFRA procedure when a random access occasion type is not configured for the CFRA procedure. In some examples, the UE 115-b may receive a higher layer control signal at 405 that indicates a random access configuration for the CFRA procedure. A random access occasion type configuration for the CFRA procedure may be absent in the higher layer control signal.

At 410, the UE 115-b may receive a control signal that configures a CFRA procedure at the UE 115-b. The control signal may indicate a random access channel preamble index and a random access channel mask index. In some examples, the random access occasion type configuration may be absent in or not indicated by the control signal.

At 415, the UE 115-b may select a first random access occasion for the CFRA procedure. The UE 115-b may select the first random access occasion between a first random access occasion type in an SBFD slot and a second random access occasion type in an uplink slot based on an absence of a random access occasion type configuration for the CFRA procedure. The first random access occasion type may correspond to an additional random access occasion as described herein.

In some examples, the UE 115-b may select the first random access occasion type for the first random access occasion based on the absence of the random access occasion type configuration for the CFRA procedure. In some examples, the UE 115-b may select the second random access occasion type for the first random access occasion based on the absence of a random access occasion configuration for the CFRA procedure.

In some examples, the UE 115-b may select the first random access occasion based on a second random access occasion type configuration or prioritization rule for a CBRA procedure and the absence of the random access occasion type configuration for the CFRA procedure. For example, the UE 115-b may select the first random access occasion based on whether a reference signal measurement satisfies a reference signal received power threshold associated with the CBRA procedure. In some examples, the second random access occasion type configuration indicates to prioritize the first random access occasion type in the SBFD slot or the second random access occasion type in the uplink slot. At 420, the UE 115-b may transmit a first random access preamble including the random access channel preamble index via the first random access occasion according to the random access channel mask index.

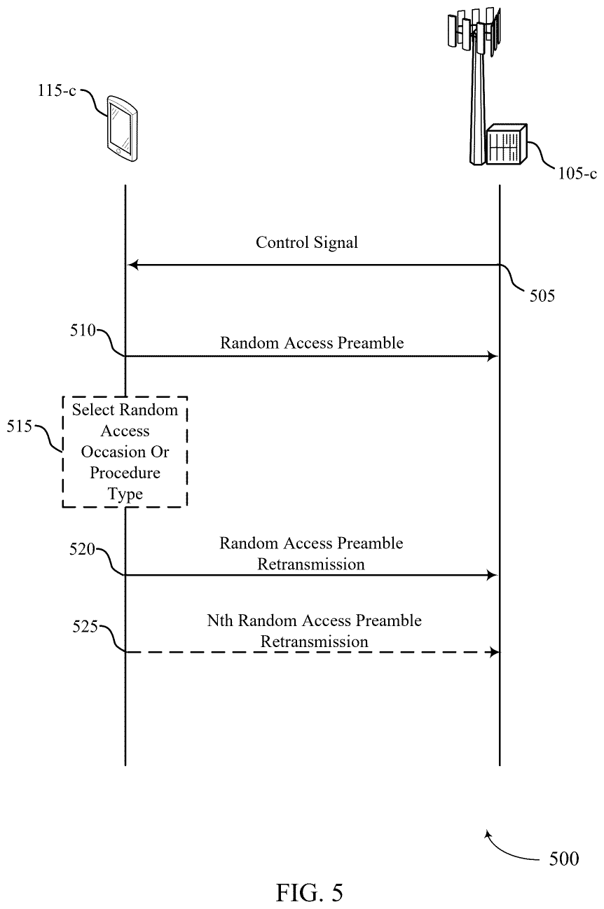

FIG. 5 shows an example of a process flow 500 that supports random access procedures for different random access occasion types in accordance with one or more aspects of the present disclosure. The process flow 500 may implement aspects of a wireless communications system 100, a wireless communications system 200, and a random access retransmission scheme 300 through 303 described herein. For example, the process flow 500 may be implemented by a UE 115-c and a network entity 105-c, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-c and the network entity 105-c are shown performing the operations of the process flow 500, some aspects of some operations may also be performed by one or more other wireless devices.

The process flow 500 may correspond to an example of the UE 115-c performing retransmissions after an initial transmission of a random access preamble. For example, at 505, the UE 115-c may receive a control signal that configures a CFRA procedure at the UE 115-c. The control signal may indicate a random access channel preamble index, a random access channel mask index, and a first random access occasion type for the CFRA procedure.

At 510, the UE 115-c may transmit a first random access preamble for an initial attempt of the CFRA procedure. For example, the UE 115-c may transmit a first random access preamble for the CFRA procedure including the random access channel preamble index via a first random access occasion of the first random access occasion type according to the random access channel mask index.

The UE 115-c may attempt retransmissions of the first random access preamble if there is communications failure of the first random access preamble via the first random access occasion. For example, at 515, the UE 115-c may select a second random access occasion for a retransmission of the first random access preamble between the first random access occasion type and a second random access occasion type based on a communications failure of the first random access preamble via the first random access occasion. The UE 115-c may retransmit the first random access preamble via the second random access occasion at 520.

In some examples, the UE 115-c may switch random access occasion types or random access procedure types after performing a threshold quantity of retransmission attempts. For example, the UE 115-c may perform an Nth retransmission attempt of the random access preamble at 525, where the random access occasion type or the random access procedure type, or both, are switched.

In some examples, the UE 115-c may transmit a second random access preamble for the CFRA procedure via a third random access occasion of the second random access occasion type based on satisfying a threshold quantity of retransmissions using the first random access occasion type. For example, the UE 115-c may switch random access occasion types after performing a threshold quantity of retransmission attempts. The UE 115-c may switch from transmitting using a random access occasion in an SBFD slot to a random access occasion in an uplink slot, or the UE 115-c may switch from transmitting using a random access occasion in an uplink slot to a random access occasion in an SBFD slot.

In some examples, the UE 115-c may transmit a second random access preamble for a CBRA procedure via a third random access occasion of the first random access occasion type based on satisfying a threshold quantity of retransmissions. For example, the UE 115-c may switch random access procedure types after performing a threshold quantity of retransmission attempts. For example, the UE 115-c may switch from performing a CFRA procedure to a CBRA procedure or from performing a CBRA procedure to a CFRA procedure.

The UE 115-c may adjust or maintain power control parameters for the retransmission attempt after switching the random access occasion type or random access procedure type. For example, when switching random access occasion types, the UE 115-c may reset or maintain a power control ramping counter. In some examples, the UE 115-c may maintain a power control ramping counter, where the second random access preamble is transmitted according to power control parameters associated with the first random access occasion type. In some examples, the UE 115-c may reset a power control ramping counter, where the second random access preamble is transmitted according to power control parameters associated with the second random access occasion type.

When the UE 115-c switches random access procedure types, the UE 115-c may reselect a synchronization signal block index to obtain a pathloss measurement for the CBRA procedure. In some examples, the UE 115-c may reset a power ramping counter based on switching to the CBRA procedure. In some examples, the UE 115-c may maintain a power ramping counter associated with the CFRA procedure after switching to the CBRA procedure.

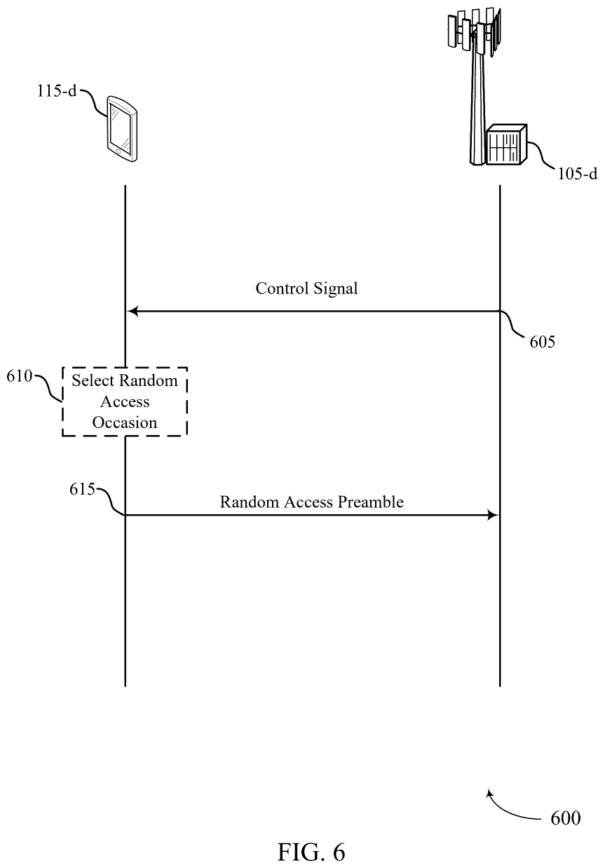

FIG. 6 shows an example of a process flow 600 that supports random access procedures for different random access occasion types in accordance with one or more aspects of the present disclosure. The process flow 600 may implement aspects of a wireless communications system 100 and a wireless communications system 200 described herein. For example, the process flow 600 may be implemented by a UE 115-d and a network entity 105-d, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-d and the network entity 105-d are shown performing the operations of the process flow 600, some aspects of some operations may also be performed by one or more other wireless devices.

The process flow 600 may correspond to an example of the UE 115-d being configured for a CBRA procedure and selecting between a first random access occasion type and a second random access occasion type for the CBRA procedure. In some examples, a signal that configures or triggers the CBRA procedure may indicate a random access occasion type for the CBRA procedure.

At 605, the UE 115-d may receive a control signal that configures or triggers a CBRA procedure at the UE 115-d. The control signal may indicate a random access channel preamble index, a random access channel mask index, and a random access occasion type configuration for the CBRA procedure.

At 610, the UE 115-d may select a random access occasion type for the CBRA procedure. For example, the UE 115-d may select a first random access occasion type in an SBFD slot or a second random access occasion type in an uplink slot based on the random access occasion type configuration indicated by the control signal. In some examples, the UE 115-d may select the first random access occasion type in the SBFD slot for the CBRA procedure based on a reference signal measurement satisfying a reference signal received power threshold, where the random access occasion type configuration indicates the second random access occasion type in the uplink slot. In some examples, the UE 115-d may select the first random access occasion type in the SBFD slot for the CBRA procedure based on a random access occasion type configuration or a prioritization rule for the CBRA procedure.

At 615, the UE 115-d may transmit a random access preamble including the random access channel preamble index via a first random access occasion according to the random access channel mask index. The first random access occasion is selected between the first random access occasion type in the SBFD slot or the second random access occasion type in the uplink slot as described herein.

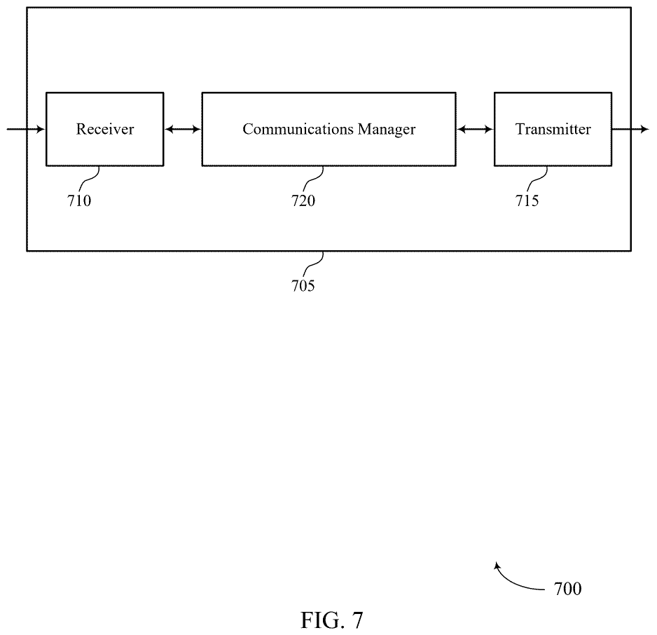

FIG. 7 shows a block diagram 700 of a device 705 that supports random access procedures for different random access occasion types in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to random access procedures for different random access occasion types). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to random access procedures for different random access occasion types). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of random access procedures for different random access occasion types as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a control signal that configures a CFRA procedure at the UE, where the control signal indicates a random access channel preamble index and a random access channel mask index. The communications manager 720 is capable of, configured to, or operable to support a means for selecting a first random access occasion for the CFRA procedure between a first random access occasion type in a sub-band full duplex slot and a second random access occasion type in an uplink slot based on an absence of a random access occasion type configuration for the CFRA procedure. The communications manager 720 is capable of, configured to, or operable to support a means for transmitting a first random access preamble including the random access channel preamble index via the first random access occasion according to the random access channel mask index.

Additionally, or alternatively, the communications manager 720 may support wireless communications in accordance with examples as disclosed herein. For example, the communications manager 720 is capable of, configured to, or operable to support a means for receiving a control signal that configures a CFRA procedure at the UE, where the control signal indicates a random access channel preamble index, a random access channel mask index, and a first random access occasion type for the CFRA procedure. The communications manager 720 is capable of, configured to, or operable to support a means for transmitting a first random access preamble for the CFRA procedure including the random access channel preamble index via a first random access occasion of the first random access occasion type according to the random access channel mask index. The communications manager 720 is capable of, configured to, or operable to support a means for selecting a second random access occasion for a retransmission of the first random access preamble between the first random access occasion type and a second random access occasion type based on a communications failure of the first random access preamble via the first random access occasion. The communications manager 720 is capable of, configured to, or operable to support a means for retransmitting the first random access preamble via the second random access occasion.

Additionally, or alternatively, the communications manager 720 may support wireless communications in accordance with examples as disclosed herein. For example, the communications manager 720 is capable of, configured to, or operable to support a means for receiving a control signal that triggers a CBRA procedure at the UE, where the control signal indicates a random access channel preamble index, a random access channel mask index, and a random access occasion type configuration for the CBRA procedure. The communications manager 720 is capable of, configured to, or operable to support a means for transmitting a random access preamble including the random access channel preamble index via a first random access occasion according to the random access channel mask index, where the first random access occasion is selected between a first random access occasion type in a sub-band full duplex slot or a second random access occasion type in an uplink slot.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

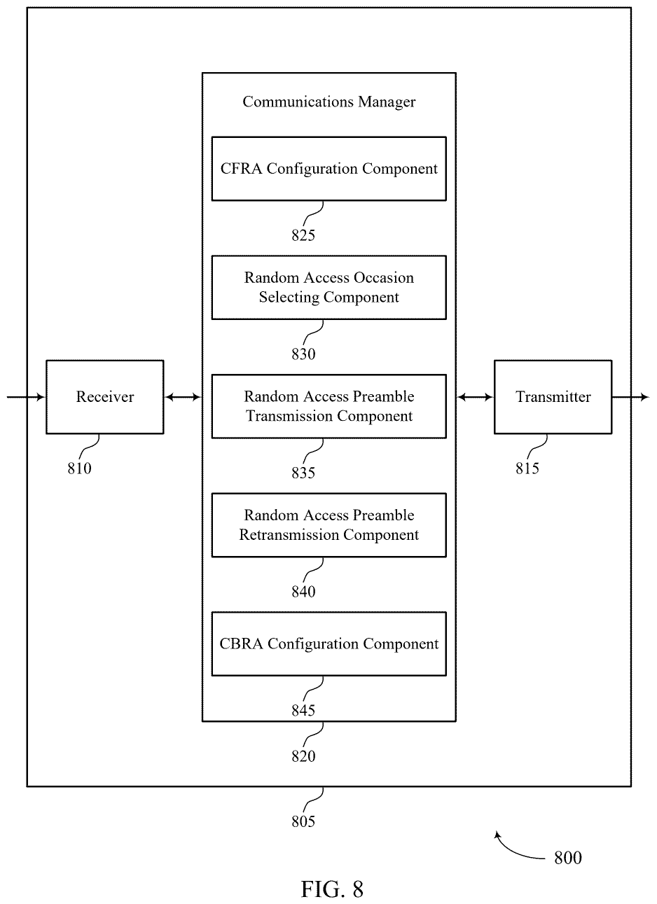

FIG. 8 shows a block diagram 800 of a device 805 that supports random access procedures for different random access occasion types in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to random access procedures for different random access occasion types). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to random access procedures for different random access occasion types). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of random access procedures for different random access occasion types as described herein. For example, the communications manager 820 may include a CFRA configuration component 825, a random access occasion selecting component 830, a random access preamble transmission component 835, a random access preamble retransmission component 840, a CBRA configuration component 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The CFRA configuration component 825 is capable of, configured to, or operable to support a means for receiving a control signal that configures a CFRA procedure at the UE, where the control signal indicates a random access channel preamble index and a random access channel mask index. The random access occasion selecting component 830 is capable of, configured to, or operable to support a means for selecting a first random access occasion for the CFRA procedure between a first random access occasion type in a sub-band full duplex slot and a second random access occasion type in an uplink slot based on an absence of a random access occasion type configuration for the CFRA procedure. The random access preamble transmission component 835 is capable of, configured to, or operable to support a means for transmitting a first random access preamble including the random access channel preamble index via the first random access occasion according to the random access channel mask index.

Additionally, or alternatively, the communications manager 820 may support wireless communications in accordance with examples as disclosed herein. The CFRA configuration component 825 is capable of, configured to, or operable to support a means for receiving a control signal that configures a CFRA procedure at the UE, where the control signal indicates a random access channel preamble index, a random access channel mask index, and a first random access occasion type for the CFRA procedure. The random access preamble transmission component 835 is capable of, configured to, or operable to support a means for transmitting a first random access preamble for the CFRA procedure including the random access channel preamble index via a first random access occasion of the first random access occasion type according to the random access channel mask index. The random access occasion selecting component 830 is capable of, configured to, or operable to support a means for selecting a second random access occasion for a retransmission of the first random access preamble between the first random access occasion type and a second random access occasion type based on a communications failure of the first random access preamble via the first random access occasion. The random access preamble retransmission component 840 is capable of, configured to, or operable to support a means for retransmitting the first random access preamble via the second random access occasion.

Additionally, or alternatively, the communications manager 820 may support wireless communications in accordance with examples as disclosed herein. The CBRA configuration component 845 is capable of, configured to, or operable to support a means for receiving a control signal that triggers a CBRA procedure at the UE, where the control signal indicates a random access channel preamble index, a random access channel mask index, and a random access occasion type configuration for the CBRA procedure. The random access preamble transmission component 835 is capable of, configured to, or operable to support a means for transmitting a random access preamble including the random access channel preamble index via a first random access occasion according to the random access channel mask index, where the first random access occasion is selected between a first random access occasion type in a sub-band full duplex slot or a second random access occasion type in an uplink slot.

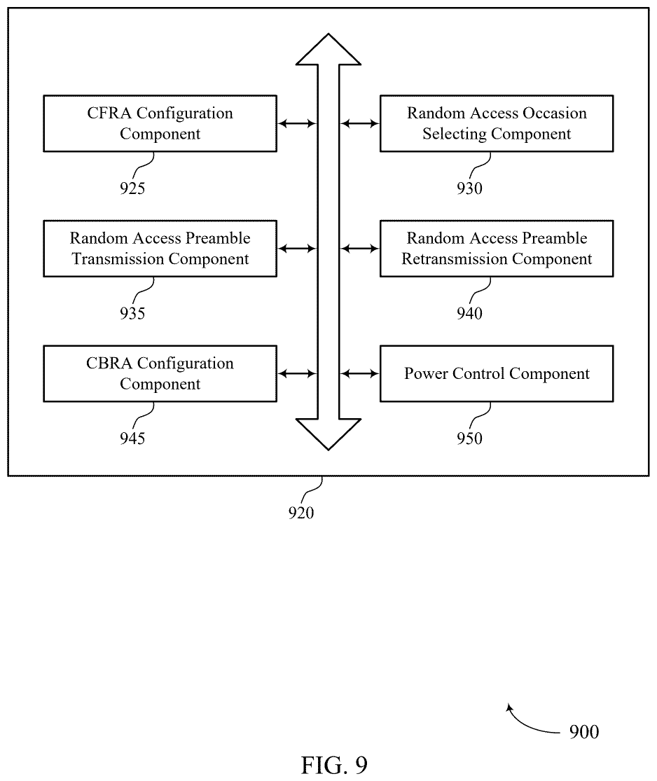

FIG. 9 shows a block diagram 900 of a communications manager 920 that supports random access procedures for different random access occasion types in accordance with one or more aspects of the present disclosure. The communications manager 920 may be an example of aspects of a communications manager 720, a communications manager 820, or both, as described herein. The communications manager 920, or various components thereof, may be an example of means for performing various aspects of random access procedures for different random access occasion types as described herein. For example, the communications manager 920 may include a CFRA configuration component 925, a random access occasion selecting component 930, a random access preamble transmission component 935, a random access preamble retransmission component 940, a CBRA configuration component 945, a power control component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The CFRA configuration component 925 is capable of, configured to, or operable to support a means for receiving a control signal that configures a CFRA procedure at the UE, where the control signal indicates a random access channel preamble index and a random access channel mask index. The random access occasion selecting component 930 is capable of, configured to, or operable to support a means for selecting a first random access occasion for the CFRA procedure between a first random access occasion type in a sub-band full duplex slot and a second random access occasion type in an uplink slot based on an absence of a random access occasion type configuration for the CFRA procedure. The random access preamble transmission component 935 is capable of, configured to, or operable to support a means for transmitting a first random access preamble including the random access channel preamble index via the first random access occasion according to the random access channel mask index.

In some examples, to support selecting the first random access occasion, the random access occasion selecting component 930 is capable of, configured to, or operable to support a means for selecting the first random access occasion type for the first random access occasion based on the absence of the random access occasion type configuration for the CFRA procedure.

In some examples, to support selecting the first random access occasion, the random access occasion selecting component 930 is capable of, configured to, or operable to support a means for selecting the second random access occasion type for the first random access occasion based on the absence of a random access occasion configuration for the CFRA procedure.

In some examples, to support selecting the first random access occasion, the random access occasion selecting component 930 is capable of, configured to, or operable to support a means for selecting the first random access occasion based on a second random access occasion type configuration or prioritization rule for a CBRA procedure and the absence of the random access occasion type configuration for the CFRA procedure.

In some examples, the first random access occasion is selected based on a reference signal measurement satisfying a reference signal received power threshold associated with the CBRA procedure.

In some examples, the second random access occasion type configuration indicates to prioritize the first random access occasion type in the sub-band full duplex slot or the second random access occasion type in the uplink slot.

In some examples, to support selecting the first random access occasion, the random access occasion selecting component 930 is capable of, configured to, or operable to support a means for selecting the first random access occasion between the first random access occasion type and the second random access occasion type based on a random access occasion configuration being absent in the control signal.

In some examples, the CFRA configuration component 925 is capable of, configured to, or operable to support a means for receiving a higher layer control signal that indicates a random access configuration for the CFRA procedure, where the random access occasion type configuration for the CFRA procedure is absent in the higher layer control signal. In some examples, the CFRA configuration component 925 is capable of, configured to, or operable to support a means for selecting the first random access occasion between the first random access occasion type and the second random access occasion type based on the random access occasion type configuration for the CFRA procedure being absent in the control signal and the higher layer control signal.

Additionally, or alternatively, the communications manager 920 may support wireless communications in accordance with examples as disclosed herein. In some examples, the CFRA configuration component 925 is capable of, configured to, or operable to support a means for receiving a control signal that configures a CFRA procedure at the UE, where the control signal indicates a random access channel preamble index, a random access channel mask index, and a first random access occasion type for the CFRA procedure. In some examples, the random access preamble transmission component 935 is capable of, configured to, or operable to support a means for transmitting a first random access preamble for the CFRA procedure including the random access channel preamble index via a first random access occasion of the first random access occasion type according to the random access channel mask index. In some examples, the random access occasion selecting component 930 is capable of, configured to, or operable to support a means for selecting a second random access occasion for a retransmission of the first random access preamble between the first random access occasion type and a second random access occasion type based on a communications failure of the first random access preamble via the first random access occasion. The random access preamble retransmission component 940 is capable of, configured to, or operable to support a means for retransmitting the first random access preamble via the second random access occasion.

In some examples, to support selecting the second random access occasion, the random access occasion selecting component 930 is capable of, configured to, or operable to support a means for selecting the first random access occasion type for the second random access occasion, where the first random access preamble is retransmitted according to the CFRA procedure.

In some examples, the random access preamble retransmission component 940 is capable of, configured to, or operable to support a means for transmitting a second random access preamble for the CFRA procedure via a third random access occasion of the second random access occasion type based on satisfying a threshold quantity of retransmissions using the first random access occasion type.

In some examples, the second random access preamble includes the random access channel preamble index and is transmitted according to the random access channel mask index.

In some examples, the second random access preamble includes a second random access channel preamble index and is transmitted according to a second random access channel mask index. In some examples, the control signal indicates the second random access channel preamble index and the second random access channel mask index.

In some examples, the power control component 950 is capable of, configured to, or operable to support a means for maintaining a power control ramping counter, where the second random access preamble is transmitted according to power control parameters associated with the first random access occasion type.

In some examples, the power control component 950 is capable of, configured to, or operable to support a means for resetting a power control ramping counter, where the second random access preamble is transmitted according to power control parameters associated with the second random access occasion type.

In some examples, the random access preamble retransmission component 940 is capable of, configured to, or operable to support a means for transmitting a second random access preamble for a CBRA procedure via a third random access occasion of the first random access occasion type based on satisfying a threshold quantity of retransmissions.

In some examples, the power control component 950 is capable of, configured to, or operable to support a means for reselecting a synchronization signal block index to obtain a pathloss measurement for the CBRA procedure. In some examples, the power control component 950 is capable of, configured to, or operable to support a means for resetting a power ramping counter based on switching to the CBRA procedure.

In some examples, the power control component 950 is capable of, configured to, or operable to support a means for reselecting a synchronization signal block index to obtain a pathloss measurement for the CBRA procedure. In some examples, the power control component 950 is capable of, configured to, or operable to support a means for maintaining a power ramping counter associated with the CFRA procedure after switching to the CBRA procedure.

In some examples, the random access preamble retransmission component 940 is capable of, configured to, or operable to support a means for transmitting a second random preamble for a CBRA procedure via a third random access occasion of the second random access occasion type based on satisfying a threshold quantity of retransmissions.

In some examples, the first random access occasion type corresponds to a sub-band full duplex slot, and the second random access occasion type corresponds to an uplink slot.

In some examples, the first random access occasion type corresponds to an uplink slot, and the second random access occasion type corresponds to a sub-band full duplex slot.

Additionally, or alternatively, the communications manager 920 may support wireless communications in accordance with examples as disclosed herein. The CBRA configuration component 945 is capable of, configured to, or operable to support a means for receiving a control signal that triggers a CBRA procedure at the UE, where the control signal indicates a random access channel preamble index, a random access channel mask index, and a random access occasion type configuration for the CBRA procedure. In some examples, the random access preamble transmission component 935 is capable of, configured to, or operable to support a means for transmitting a random access preamble including the random access channel preamble index via a first random access occasion according to the random access channel mask index, where the first random access occasion is selected between a first random access occasion type in a sub-band full duplex slot or a second random access occasion type in an uplink slot.

In some examples, the random access occasion selecting component 930 is capable of, configured to, or operable to support a means for selecting the first random access occasion type in the sub-band full duplex slot or the second random access occasion type in the uplink slot based on the random access occasion type configuration indicated by the control signal.

In some examples, the random access occasion selecting component 930 is capable of, configured to, or operable to support a means for selecting the first random access occasion type in the sub-band full duplex slot for the CBRA procedure based on a reference signal measurement satisfying a reference signal received power threshold, where the random access occasion type configuration indicates the second random access occasion type in the uplink slot.

In some examples, the random access occasion selecting component 930 is capable of, configured to, or operable to support a means for selecting the first random access occasion type in the sub-band full duplex slot for the CBRA procedure based on a random access occasion type configuration or a prioritization rule for a CBRA procedure.

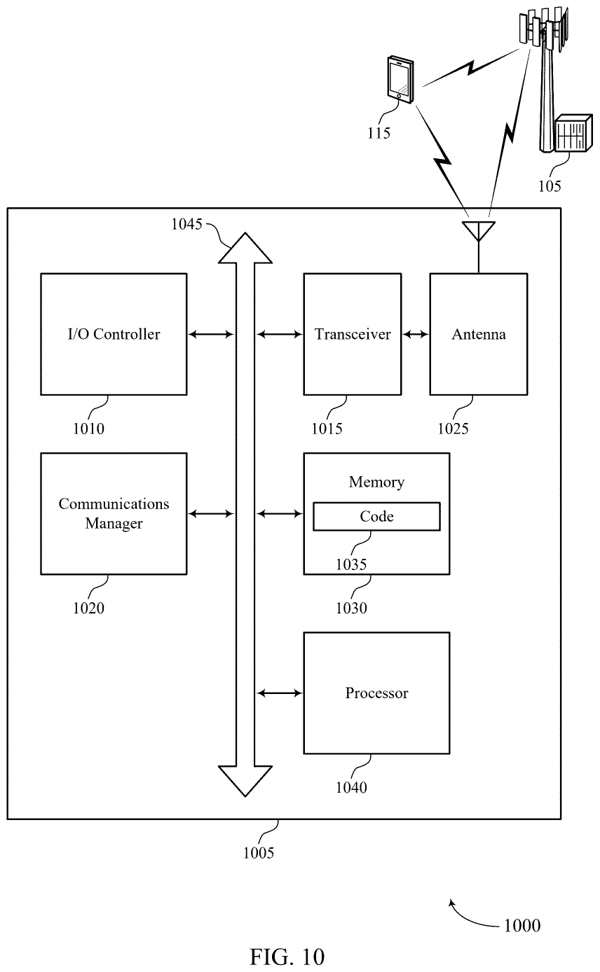

FIG. 10 shows a diagram of a system 1000 including a device 1005 that supports random access procedures for different random access occasion types in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting random access procedures for different random access occasion types). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a control signal that configures a CFRA procedure at the UE, where the control signal indicates a random access channel preamble index and a random access channel mask index. The communications manager 1020 is capable of, configured to, or operable to support a means for selecting a first random access occasion for the CFRA procedure between a first random access occasion type in a sub-band full duplex slot and a second random access occasion type in an uplink slot based on an absence of a random access occasion type configuration for the CFRA procedure. The communications manager 1020 is capable of, configured to, or operable to support a means for transmitting a first random access preamble including the random access channel preamble index via the first random access occasion according to the random access channel mask index.

Additionally, or alternatively, the communications manager 1020 may support wireless communications in accordance with examples as disclosed herein. For example, the communications manager 1020 is capable of, configured to, or operable to support a means for receiving a control signal that configures a CFRA procedure at the UE, where the control signal indicates a random access channel preamble index, a random access channel mask index, and a first random access occasion type for the CFRA procedure. The communications manager 1020 is capable of, configured to, or operable to support a means for transmitting a first random access preamble for the CFRA procedure including the random access channel preamble index via a first random access occasion of the first random access occasion type according to the random access channel mask index. The communications manager 1020 is capable of, configured to, or operable to support a means for selecting a second random access occasion for a retransmission of the first random access preamble between the first random access occasion type and a second random access occasion type based on a communications failure of the first random access preamble via the first random access occasion. The communications manager 1020 is capable of, configured to, or operable to support a means for retransmitting the first random access preamble via the second random access occasion.

Additionally, or alternatively, the communications manager 1020 may support wireless communications in accordance with examples as disclosed herein. For example, the communications manager 1020 is capable of, configured to, or operable to support a means for receiving a control signal that triggers a CBRA procedure at the UE, where the control signal indicates a random access channel preamble index, a random access channel mask index, and a random access occasion type configuration for the CBRA procedure. The communications manager 1020 is capable of, configured to, or operable to support a means for transmitting a random access preamble including the random access channel preamble index via a first random access occasion according to the random access channel mask index, where the first random access occasion is selected between a first random access occasion type in a sub-band full duplex slot or a second random access occasion type in an uplink slot.

By including or configuring the communications manager 1020 in accordance with examples as described herein, the device 1005 may support techniques for improved communication reliability, reduced power consumption, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of random access procedures for different random access occasion types as described herein, or the at least one processor 1040 and the at least one memory 1030 may be otherwise configured to, individually or collectively, perform or support such operations.

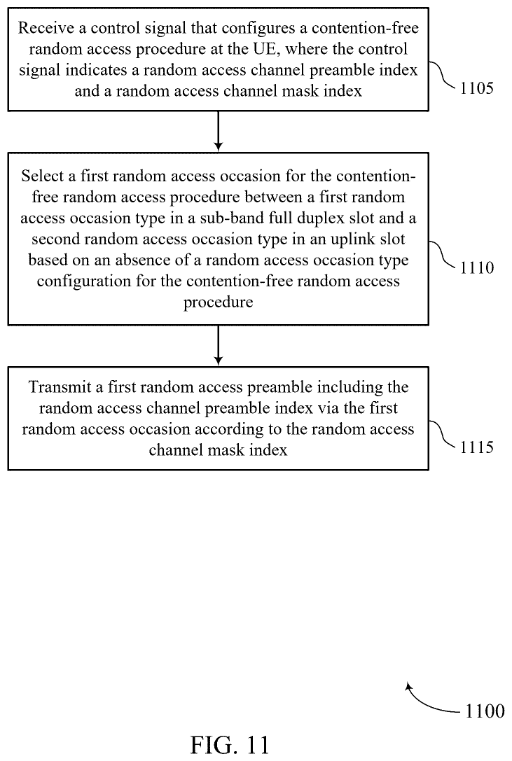

FIG. 11 shows a flowchart illustrating a method 1100 that supports random access procedures for different random access occasion types in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving a control signal that configures a CFRA procedure at the UE, where the control signal indicates a random access channel preamble index and a random access channel mask index. The operations of 1105 may be performed in accordance with examples as disclosed herein. In some examples, aspects of the operations of 1105 may be performed by a CFRA configuration component 925 as described with reference to FIG. 9.

At 1110, the method may include selecting a first random access occasion for the CFRA procedure between a first random access occasion type in a sub-band full duplex slot and a second random access occasion type in an uplink slot based on an absence of a random access occasion type configuration for the CFRA procedure. The operations of 1110 may be performed in accordance with examples as disclosed herein. In some examples, aspects of the operations of 1110 may be performed by a random access occasion selecting component 930 as described with reference to FIG. 9.

At 1115, the method may include transmitting a first random access preamble including the random access channel preamble index via the first random access occasion according to the random access channel mask index. The operations of 1115 may be performed in accordance with examples as disclosed herein. In some examples, aspects of the operations of 1115 may be performed by a random access preamble transmission component 935 as described with reference to FIG. 9.

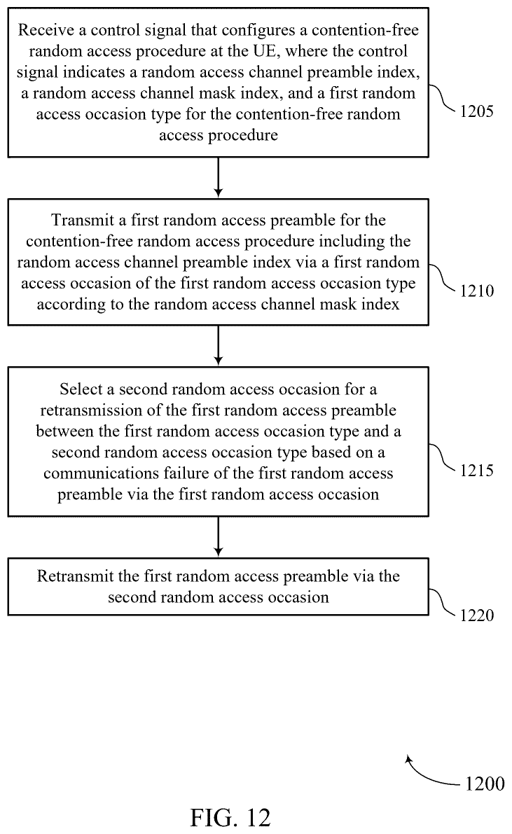

FIG. 12 shows a flowchart illustrating a method 1200 that supports random access procedures for different random access occasion types in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving a control signal that configures a CFRA procedure at the UE, where the control signal indicates a random access channel preamble index, a random access channel mask index, and a first random access occasion type for the CFRA procedure. The operations of 1205 may be performed in accordance with examples as disclosed herein. In some examples, aspects of the operations of 1205 may be performed by a CFRA configuration component 925 as described with reference to FIG. 9.

At 1210, the method may include transmitting a first random access preamble for the CFRA procedure including the random access channel preamble index via a first random access occasion of the first random access occasion type according to the random access channel mask index. The operations of 1210 may be performed in accordance with examples as disclosed herein. In some examples, aspects of the operations of 1210 may be performed by a random access preamble transmission component 935 as described with reference to FIG. 9.

At 1215, the method may include selecting a second random access occasion for a retransmission of the first random access preamble between the first random access occasion type and a second random access occasion type based on a communications failure of the first random access preamble via the first random access occasion. The operations of 1215 may be performed in accordance with examples as disclosed herein. In some examples, aspects of the operations of 1215 may be performed by a random access occasion selecting component 930 as described with reference to FIG. 9.

At 1220, the method may include retransmitting the first random access preamble via the second random access occasion. The operations of 1220 may be performed in accordance with examples as disclosed herein. In some examples, aspects of the operations of 1220 may be performed by a random access preamble retransmission component 940 as described with reference to FIG. 9.

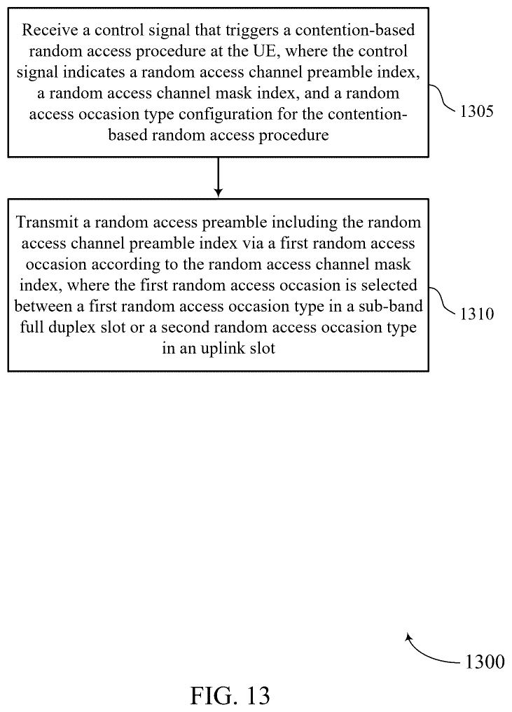

FIG. 13 shows a flowchart illustrating a method 1300 that supports random access procedures for different random access occasion types in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving a control signal that triggers a CBRA procedure at the UE, where the control signal indicates a random access channel preamble index, a random access channel mask index, and a random access occasion type configuration for the CBRA procedure. The operations of 1305 may be performed in accordance with examples as disclosed herein. In some examples, aspects of the operations of 1305 may be performed by a CBRA configuration component 945 as described with reference to FIG. 9.

At 1310, the method may include transmitting a random access preamble including the random access channel preamble index via a first random access occasion according to the random access channel mask index, where the first random access occasion is selected between a first random access occasion type in a sub-band full duplex slot or a second random access occasion type in an uplink slot. The operations of 1310 may be performed in accordance with examples as disclosed herein. In some examples, aspects of the operations of 1310 may be performed by a random access preamble transmission component 935 as described with reference to FIG. 9.

The following provides an overview of aspects of the present disclosure:

Aspect 1: A method for wireless communications at a UE, comprising: receiving a control signal that configures a contention-free random access procedure at the UE, wherein the control signal indicates a random access channel preamble index and a random access channel mask index; selecting a first random access occasion for the contention-free random access procedure between a first random access occasion type in a sub-band full duplex slot and a second random access occasion type in an uplink slot based at least in part on an absence of a random access occasion type configuration for the contention-free random access procedure; and transmitting a first random access preamble comprising the random access channel preamble index via the first random access occasion according to the random access channel mask index.

Aspect 2: The method of aspect 1, wherein selecting the first random access occasion comprises: selecting the first random access occasion type for the first random access occasion based at least in part on the absence of the random access occasion type configuration for the contention-free random access procedure.

Aspect 3: The method of any of aspects 1 through 2, wherein selecting the first random access occasion comprises: selecting the second random access occasion type for the first random access occasion based at least in part on the absence of a random access occasion configuration for the contention-free random access procedure.

Aspect 4: The method of any of aspects 1 through 3, wherein selecting the first random access occasion comprises: selecting the first random access occasion based at least in part on a second random access occasion type configuration or prioritization rule for a contention-based random access procedure and the absence of the random access occasion type configuration for the contention-free random access procedure.

Aspect 5: The method of aspect 4, wherein the first random access occasion is selected based at least in part on a reference signal measurement satisfying a reference signal received power threshold associated with the contention-based random access procedure.

Aspect 6: The method of any of aspects 4 through 5, wherein the second random access occasion type configuration indicates to prioritize the first random access occasion type in the sub-band full duplex slot or the second random access occasion type in the uplink slot.

Aspect 7: The method of any of aspects 1 through 6, wherein selecting the first random access occasion comprises: selecting the first random access occasion between the first random access occasion type and the second random access occasion type based at least in part on a random access occasion configuration being absent in the control signal.

Aspect 8: The method of any of aspects 1 through 7, further comprising: receiving a higher layer control signal that indicates a random access configuration for the contention-free random access procedure, wherein the random access occasion type configuration for the contention-free random access procedure is absent in the higher layer control signal; and wherein selecting the first random access occasion comprises: selecting the first random access occasion between the first random access occasion type and the second random access occasion type based at least in part on the random access occasion type configuration for the contention-free random access procedure being absent in the control signal and the higher layer control signal.

Aspect 9: A method for wireless communications at a UE, comprising: receiving a control signal that configures a contention-free random access procedure at the UE, wherein the control signal indicates a random access channel preamble index, a random access channel mask index, and a first random access occasion type for the contention-free random access procedure; transmitting a first random access preamble for the contention-free random access procedure comprising the random access channel preamble index via a first random access occasion of the first random access occasion type according to the random access channel mask index; selecting a second random access occasion for a retransmission of the first random access preamble between the first random access occasion type and a second random access occasion type based at least in part on a communications failure of the first random access preamble via the first random access occasion; and retransmitting the first random access preamble via the second random access occasion.

Aspect 10: The method of aspect 9, wherein selecting the second random access occasion comprises: selecting the first random access occasion type for the second random access occasion, wherein the first random access preamble is retransmitted according to the contention-free random access procedure.

Aspect 11: The method of aspect 10, further comprising: transmitting a second random access preamble for the contention-free random access procedure via a third random access occasion of the second random access occasion type based at least in part on satisfying a threshold quantity of retransmissions using the first random access occasion type.

Aspect 12: The method of aspect 11, wherein the second random access preamble comprises the random access channel preamble index and is transmitted according to the random access channel mask index.

Aspect 13: The method of any of aspects 11 through 12, wherein the second random access preamble comprises a second random access channel preamble index and is transmitted according to a second random access channel mask index, and the control signal indicates the second random access channel preamble index and the second random access channel mask index.

Aspect 14: The method of any of aspects 11 through 13, further comprising: maintaining a power control ramping counter, wherein the second random access preamble is transmitted according to power control parameters associated with the first random access occasion type.

Aspect 15: The method of any of aspects 11 through 14, further comprising: resetting a power control ramping counter, wherein the second random access preamble is transmitted according to power control parameters associated with the second random access occasion type.

Aspect 16: The method of any of aspects 10 through 15, further comprising: transmitting a second random access preamble for a contention-based random access procedure via a third random access occasion of the first random access occasion type based at least in part on satisfying a threshold quantity of retransmissions.

Aspect 17: The method of aspect 16, further comprising: reselecting a synchronization signal block index to obtain a pathloss measurement for the contention-based random access procedure; and resetting a power ramping counter based at least in part on switching to the contention-based random access procedure.

Aspect 18: The method of any of aspects 16 through 17, further comprising: reselecting a synchronization signal block index to obtain a pathloss measurement for the contention-based random access procedure; and maintaining a power ramping counter associated with the contention-free random access procedure after switching to the contention-based random access procedure.

Aspect 19: The method of any of aspects 10 through 18, further comprising: transmitting a second random preamble for a contention-based random access procedure via a third random access occasion of the second random access occasion type based at least in part on satisfying a threshold quantity of retransmissions.

Aspect 20: The method of any of aspects 9 through 19, wherein the first random access occasion type corresponds to a sub-band full duplex slot, and the second random access occasion type corresponds to an uplink slot.

Aspect 21: The method of any of aspects 9 through 20, wherein the first random access occasion type corresponds to an uplink slot, and the second random access occasion type corresponds to a sub-band full duplex slot.

Aspect 22: A method for wireless communications at a UE, comprising: receiving a control signal that triggers a contention-based random access procedure at the UE, wherein the control signal indicates a random access channel preamble index, a random access channel mask index, and a random access occasion type configuration for the contention-based random access procedure; and transmitting a random access preamble comprising the random access channel preamble index via a first random access occasion according to the random access channel mask index, wherein the first random access occasion is selected between a first random access occasion type in a sub-band full duplex slot or a second random access occasion type in an uplink slot.

Aspect 23: The method of aspect 22, further comprising: selecting the first random access occasion type in the sub-band full duplex slot or the second random access occasion type in the uplink slot based at least in part on the random access occasion type configuration indicated by the control signal.

Aspect 24: The method of any of aspects 22 through 23, further comprising: selecting the first random access occasion type in the sub-band full duplex slot for the contention-based random access procedure based at least in part on a reference signal measurement satisfying a reference signal received power threshold, wherein the random access occasion type configuration indicates the second random access occasion type in the uplink slot.

Aspect 25: The method of any of aspects 22 through 24, further comprising: selecting the first random access occasion type in the sub-band full duplex slot for the contention-based random access procedure based at least in part on a random access occasion type configuration or a prioritization rule for a contention-based random access procedure.

Aspect 26: A UE for wireless communications, comprising one or more memories storing processor-executable code, and one or more processors coupled with the one or more memories and individually or collectively operable to execute the code to cause the UE to perform a method of any of aspects 1 through 8.

Aspect 27: A UE for wireless communications, comprising at least one means for performing a method of any of aspects 1 through 8.

Aspect 28: A non-transitory computer-readable medium storing code for wireless communications, the code comprising instructions executable by one or more processors to perform a method of any of aspects 1 through 8.

Aspect 29: A UE for wireless communications, comprising one or more memories storing processor-executable code, and one or more processors coupled with the one or more memories and individually or collectively operable to execute the code to cause the UE to perform a method of any of aspects 9 through 21.

Aspect 30: A UE for wireless communications, comprising at least one means for performing a method of any of aspects 9 through 21.

Aspect 31: A non-transitory computer-readable medium storing code for wireless communications, the code comprising instructions executable by one or more processors to perform a method of any of aspects 9 through 21.

Aspect 32: A UE for wireless communications, comprising one or more memories storing processor-executable code, and one or more processors coupled with the one or more memories and individually or collectively operable to execute the code to cause the UE to perform a method of any of aspects 22 through 25.

Aspect 33: A UE for wireless communications, comprising at least one means for performing a method of any of aspects 22 through 25.

Aspect 34: A non-transitory computer-readable medium storing code for wireless communications, the code comprising instructions executable by one or more processors to perform a method of any of aspects 22 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control signal that configures a contention-free random access procedure at the UE, wherein the control signal indicates a random access channel preamble index, a random access channel mask index, and a first random access occasion type for the contention-free random access procedure;
transmit a first random access preamble for the contention-free random access procedure comprising the random access channel preamble index via a first random access occasion of the first random access occasion type according to the random access channel mask index;
select a second random access occasion for a retransmission of the first random access preamble between the first random access occasion type and a second random access occasion type based at least in part on a communications failure of the first random access preamble via the first random access occasion; and
retransmit the first random access preamble via the second random access occasion.

2. The UE of claim 1, wherein, to select the second random access occasion, the one or more processors are individually or collectively operable to execute the code to cause the UE to:
select the first random access occasion type for the second random access occasion, wherein the first random access preamble is retransmitted according to the contention-free random access procedure.

3. The UE of claim 2, wherein the one or more processors are individually or collectively further operable to execute the code to cause the UE to:
transmit a second random access preamble for a contention-based random access procedure via a third random access occasion of the first random access occasion type based at least in part on satisfying a threshold quantity of retransmissions.

4. The UE of claim 3, wherein the one or more processors are individually or collectively further operable to execute the code to cause the UE to:
reselect a synchronization signal block index to obtain a pathloss measurement for the contention-based random access procedure; and
reset a power ramping counter based at least in part on switching to the contention-based random access procedure.

5. The UE of claim 3, wherein the one or more processors are individually or collectively further operable to execute the code to cause the UE to:
reselect a synchronization signal block index to obtain a pathloss measurement for the contention-based random access procedure; and
maintain a power ramping counter associated with the contention-free random access procedure after switching to the contention-based random access procedure.

6. The UE of claim 2, wherein the one or more processors are individually or collectively further operable to execute the code to cause the UE to:
transmit a second random access preamble for the contention-free random access procedure via a third random access occasion of the second random access occasion type based at least in part on satisfying a threshold quantity of retransmissions using the first random access occasion type.

7. The UE of claim 6, wherein the second random access preamble comprises the random access channel preamble index and is transmitted according to the random access channel mask index.

8. The UE of claim 6, wherein:
the second random access preamble comprises a second random access channel preamble index and is transmitted according to a second random access channel mask index; and
the control signal indicates the second random access channel preamble index and the second random access channel mask index.

9. The UE of claim 6, wherein the one or more processors are individually or collectively further operable to execute the code to cause the UE to:
maintain a power control ramping counter, wherein the second random access preamble is transmitted according to power control parameters associated with the first random access occasion type.

10. The UE of claim 6, wherein the one or more processors are individually or collectively further operable to execute the code to cause the UE to:
reset a power control ramping counter, wherein the second random access preamble is transmitted according to power control parameters associated with the second random access occasion type.

11. The UE of claim 1, wherein:
the first random access occasion type corresponds to a sub-band full duplex slot, and the second random access occasion type corresponds to an uplink slot; or
the first random access occasion type corresponds to an uplink slot, and the second random access occasion type corresponds to a sub-band full duplex slot.

12. A user equipment (UE), comprising:
one or more memories storing processor-executable code; and
one or more processors coupled with the one or more memories and individually or collectively operable to execute the code to cause the UE to:
receive a control signal that triggers a contention-based random access procedure at the UE, wherein the control signal indicates a random access channel preamble index, a random access channel mask index, and a random access occasion type configuration for the contention-based random access procedure; and
transmit a random access preamble comprising the random access channel preamble index via a first random access occasion according to the random access channel mask index, wherein the first random access occasion is selected between a first random access occasion type in a sub-band full duplex slot or a second random access occasion type in an uplink slot.

13. The UE of claim 12, wherein the one or more processors are individually or collectively further operable to execute the code to cause the UE to:
select the first random access occasion type in the sub-band full duplex slot for the contention-based random access procedure based at least in part on a random access occasion type configuration or a prioritization rule for a contention-based random access procedure.

14. The UE of claim 12, wherein the one or more processors are individually or collectively further operable to execute the code to cause the UE to:
select the first random access occasion type in the sub-band full duplex slot or the second random access occasion type in the uplink slot based at least in part on the random access occasion type configuration indicated by the control signal.

15. The UE of claim 12, wherein the one or more processors are individually or collectively further operable to execute the code to cause the UE to:
select the first random access occasion type in the sub-band full duplex slot for the contention-based random access procedure based at least in part on a reference signal measurement satisfying a reference signal received power threshold, wherein the random access occasion type configuration indicates the second random access occasion type in the uplink slot.

16. A method for wireless communications at a user equipment (UE), comprising:
receiving a control signal that configures a contention-free random access procedure at the UE, wherein the control signal indicates a random access channel preamble index, a random access channel mask index, and a first random access occasion type for the contention-free random access procedure;
transmitting a first random access preamble for the contention-free random access procedure comprising the random access channel preamble index via a first random access occasion of the first random access occasion type according to the random access channel mask index;
selecting a second random access occasion for a retransmission of the first random access preamble between the first random access occasion type and a second random access occasion type based at least in part on a communications failure of the first random access preamble via the first random access occasion; and
retransmitting the first random access preamble via the second random access occasion.

17. The method of claim 16, wherein selecting the second random access occasion comprises:
selecting the first random access occasion type for the second random access occasion, wherein the first random access preamble is retransmitted according to the contention-free random access procedure.

18. The method of claim 17, further comprising:
transmitting a second random access preamble for a contention-based random access procedure via a third random access occasion of the first random access occasion type based at least in part on satisfying a threshold quantity of retransmissions.

19. The method of claim 18, further comprising:
reselecting a synchronization signal block index to obtain a pathloss measurement for the contention-based random access procedure; and
resetting a power ramping counter based at least in part on switching to the contention-based random access procedure.

20. The method of claim 18, further comprising:
reselecting a synchronization signal block index to obtain a pathloss measurement for the contention-based random access procedure; and
maintaining a power ramping counter associated with the contention-free random access procedure after switching to the contention-based random access procedure.
